(19) United States
(12) Patent Application Publication
(10) Pub. No.: US 2016/0274819 A1
(43) Pub. Date: Sep. 22, 2016

(54) MEMORY SYSTEM INCLUDING HOST AND A PLURALITY OF STORAGE DEVICES AND DATA MIGRATION METHOD THEREOF

(71) Applicant: Samsung Electronics Co., Ltd., Suwon-si (KR)

(72) Inventor: Sang-Hoon Choi, Seoul (KR)

(21) Appl. No.: 15/000,489

(22) Filed: Jan. 19, 2016

(30) Foreign Application Priority Data
Mar. 16, 2015 (KR) 10-2015-0036089

(51) Int. Cl. G06F 3/06

(52) U.S. Cl. CPC G06F 3/0647; G06F 3/0604; G06F 3/064; G06F 3/0643; G06F 3/0679

(57) ABSTRACT

A data migration method of a memory system including first and second storage devices includes performing a read operation of original data stored in the first storage device in response to a data migration request, obtaining parameters of files included in the original data with reference to metadata of the original data, re-arranging the files included in the original data based on at least one of the parameters, and storing the files included in the original data in the second storage device according to the re-arrangement.

### CROSS-REFERENCE TO RELATED APPLICATIONS

This US non-provisional patent application claims priority under 35 USC §119 to Korean Patent Application No. 10-2015-0036089, filed on Mar. 16, 2015, the entirety of which is hereby incorporated by reference.

### BACKGROUND

The present disclosure relates to memory systems and, more particularly, to a memory system including a host and a plurality of storage devices and/or a data migration method thereof.

Semiconductor memory devices may be classified into volatile memory devices such as DRAM and SRAM and nonvolatile memory devices such as EEPROM, FRAM, PRAM, MRAM, and flash memory. Volatile memory devices lose their stored data when their power supplies are interrupted, while nonvolatile memory devices retain their stored data even when their power supplies are interrupted. For example, a flash memory has various advantages, for example, high programming speed, low power consumption, high-capacity data storage, etc. Accordingly, data storage devices based on a flash memory have been widely used.

Data storage devices based on a flash memory include a solid state drive (SSD), which is replacing a hard disk drive, and a memory card (e.g., an SD card or an MMC). Since such a semiconductor memory device may be manufactured in a small size, it may be embedded in a handheld electronic device or the like. Embedded memory devices may be, for example, an embedded SSD (eSSD) and an embedded MMC (eMMC). The eSSD may be used in, for example, a laptop computer, a tablet PC or an e-book, and the eMMC may be used in, for example, a mobile device or the like.

A memory system may include a plurality of homogenous or heterogeneous data storage devices. Accordingly, copying data in a block unit, which is greater than a file unit, or a storage device unit may occur between such data storage devices.

### SUMMARY

The present disclosure relates to memory systems and/or data migration methods thereof.

According to an example embodiments of inventive concepts, a data migration method of a memory system including first and second storage devices may include performing a read operation of original data stored in the first storage device in response to a data migration request, obtaining parameters of files included in the original data with reference to metadata of the original data, re-arranging the files based on at least one of the parameters, and storing the files included in the original data in the second storage device according to the re-arrangement.

According to an example embodiment of inventive concepts, a data migration method of a memory system including first memory blocks and second memory blocks may include performing a read operation of original data stored in the first memory blocks in response to a data migration request, obtaining parameters of files included in the original data with reference to metadata of the original data, re-arranging the files based on at least one of the parameters, and storing the files included in the original data in the second memory blocks included in the storage device according to the re-arrangement.

According to an example embodiment of inventive concepts, a data migration method of a memory system including first and second storage devices may include reading original data stored in the first storage device in response to a data migration request, obtaining parameters of files with reference to metadata of the original data, re-arranging the files included in the original data based on at least one of the parameters, generating a write order sequence for the re-arranged files based on set criteria, and writing the files in the second storage device according to the write order sequence.

### BRIEF DESCRIPTION OF THE DRAWINGS

The forgoing and other features of inventive concepts will be described below in more detail with reference to the accompanying drawings of non-limiting example embodiments of inventive concepts in which like reference characters refer to like parts throughout the different views. The drawings are not necessarily to scale, emphasis instead being placed upon illustrating principles of inventive concepts. In the drawings:

FIG. 1 is a block diagram of a memory system according to an example embodiment of inventive concepts;

FIG. 2 illustrates a data write operation in a second storage device in FIG. 1;

FIG. 3 illustrates a method of performing data migration based on file time information according to an example embodiment of inventive concepts;

FIG. 4 is a writing method in a second storage device by data migration based on file time information;

FIG. 5 is a flowchart illustrating a data migration method based on metadata of original data according to an example embodiment of inventive concepts;

FIG. 6 is a flowchart illustrating a method of arranging files included in original data based on a parameter obtained from the metadata in FIG. 5;

FIG. 7 is a flowchart illustrating another method of arranging files included in original data based on a parameter obtained from the metadata in FIG. 5;

FIG. 8 is a flowchart illustrating still another method of arranging files included in original data based on a parameter obtained from the metadata in FIG. 5;

FIG. 9 is a block diagram of a memory system according to an example embodiment of inventive concepts;

FIG. 10 is a flowchart illustrating another data migration method based on metadata of original data according to an example embodiment of inventive concepts;

FIG. 11 is a block diagram of a user system according to an example embodiment of inventive concepts; and

FIG. 12 is a block diagram of a user system according to an example embodiment of inventive concepts.

### DETAILED DESCRIPTION

Various example embodiments will now be described more fully with reference to the accompanying drawings, in which some example embodiments are shown. Example embodiments may, however, be embodied in many different forms and should not be construed as being limited to the example embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Meanwhile, when it is possible to implement any embodiment in any other way, a function or an operation specified in a specific block may be performed differently from a flow specified in a flowchart. For example, two consecutive blocks may actually perform the function or the operation simultaneously, and the two blocks may perform the function or the operation conversely according to a related operation or function.

Expressions such as “at least one of,” when preceding a list of elements, modify the entire list of elements and do not modify the individual elements of the list.

The example embodiments as disclosed herein may comprise program code including program instructions, software components, software modules, data files, data structures, and/or the like that are implemented by one or more physical hardware devices. Examples of program code include both machine code produced by a compiler and higher level program code that is executed using an interpreter. The hardware devices include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

The hardware devices may also include one or more storage devices. The one or more storage devices may be computer-readable storage media, such as random access memory (RAM), read only memory (ROM), a permanent mass storage device (such as a disk drive), and/or any other like data storage mechanism capable of storing and recording data. The one or more storage devices may be configured to store program code for one or more operating systems and/or the program code for implementing the example embodiments as described above. The program code may also be loaded from a separate computer readable storage medium into the one or more storage devices and/or the one or more processors using a drive mechanism. Such separate computer readable storage medium may include a USB flash drive, memory stick, Blu-ray/DVD/CD-ROM drive, memory card, and/or other like computer readable storage medium (not shown). The program code may be loaded into the one or more storage devices and/or the one or more processors from a remote data storage device via a network interface, rather than via a computer readable storage medium. Additionally, the program code may be loaded into the one or more storage devices and/or the one or more processors from a remote computing system that is configured to transfer and/or distribute the program code over a network. The remote computing system may transfer and/or distribute the program code via a wired interface, an air interface, and/or any other like tangible or intangible medium. The one or more processors, the one or more storage devices, and/or the program code may be specially designed and constructed for the purposes of the example embodiments, or they may be known devices that are altered and/or modified for the purposes of the example embodiments.

Hereinafter, some example embodiments will be explained in further detail with reference to the accompanying drawings.

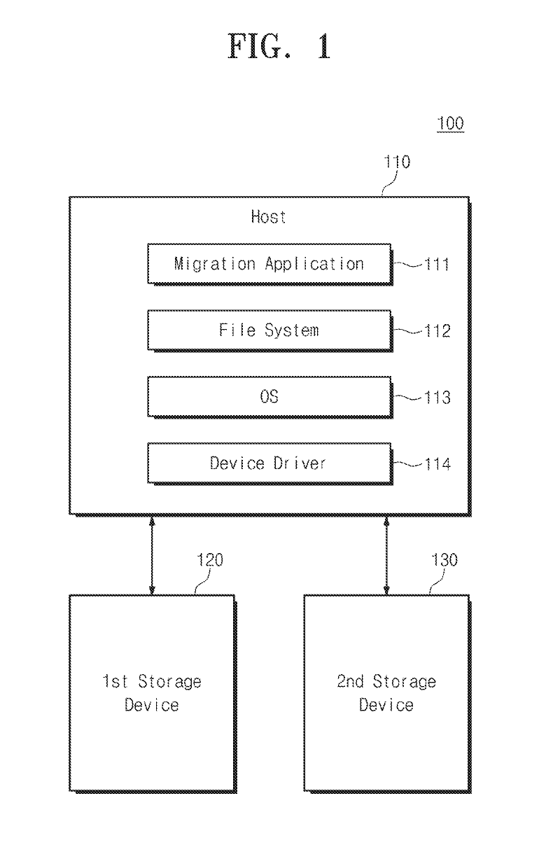

FIG. 1 is a block diagram of a memory system 100 according to an example embodiment of inventive concepts. As illustrated, the memory system 100 may include a host 110 and first and second storage devices 120 and 130. For example, the memory system 100 may be provided as one of computing systems such as an ultra mobile PC (UMPC), a workstation, a net-book, a personal digital assistant (PDA), a portable computer, a web tablet, a wireless phone, a mobile phone, a smartphone, an e-book, a portable multimedia player (PMP), a portable game console, a navigation device, a black box, a digital camera, a digital multimedia broadcasting (DMP) player, a digital audio recorder, a digital audio player, a digital picture recorder, a digital picture player, a digital video recorder, and a digital video player.

The host 110 may be configured to access the first and second storage devices 120 and 130. For example, the host 110 may store data in the first and second storage devices 120 and 130. The host 110 may read the data stored in the first and second storage devices 120 and 130. The host 110 may perform various operations based on the data stored in the first and second storage devices 120 and 130. The host 110 may allow data to migrate from the first storage device 120 to the second storage device 130 in a unit greater than a file unit. For example, the host 110 may allow data to migrate in a memory block unit. Hereinafter, data migration refers to migrating data in a unit relatively greater than a file unit.

The host 110 may include a migration application 111, a file system 112, an operating system (OS) 113, and a device driver 114. The migration application 111 may manage data migration between the first and second storage devices 120 and 130. The host 110 may receive a data migration request through a user interface. The migration application 111 may read data from, for example, the first storage device 120 according to the data migration request. The migration application 111 may generate a write order sequence of the read data according to desired (or alternatively, predetermined) criteria. The host 110 may write the data, for example, the second storage device 130 according to the write order sequence.

The file system 112 may manage storage spaces of the first and second storage devices 120 and 130. The file system 112 may manage data stored in the first and second storage devices 120 and 130. For example, the operating system 113 may access data of the first and second storage devices 120 and 130 based on the file system 112. For example, the file system 112 may include FAT (File Allocation Table), FAT32, NTFS (NT File System), HFS (Hierarchical File System), JSF2 (Journaled File System2), XFS, ODS-5 (On-Disk Structure-5), UDF, ZFS, UFS (Unix File System), ext2, ext3, ext4, ReiserFS, Reiser4, ISO 9660, Gnome VFS, BFS or WinFS.

The operating system 113 may control the overall operation of the memory system 100. For example, the operating system 113 may include Windows, Windows CE, Windows Mobile, Mac OS, Linux, UNIX, VMS, OS/2, Solaris, Symbian OS, Palm OS, BSD, DOS, Android, Bada OS or the like.

The device driver 114 may be a program to control devices included in the host 110 or devices connected to the host 110. The device driver 114 may perform an operation to convert input/output commands into a message corresponding to each of the devices. The device driver 114 may control the first and second storage devices 120 and 130. For example, the device driver 114 may receive a data read request for the data migration from the operating system 113. The device driver 114 may transmit a message corresponding to the received data read request to, for example, the first storage device 120 in response to the received data read request. The device driver 114 may receive a data write request for the data migration from the operating system 113. The device driver 114 may transmit data corresponding to the received data write request to, for example, the second storage device 130 in response to the received data write request.

When the device driver 114 is a program, the program may include program instructions, software components, software modules, data files, data structures, and/or the like that are implemented by one or more physical hardware devices. Examples of program include both machine code produced by a compiler and higher level program code that is executed using an interpreter. The hardware devices include one or more processors. The one or more processors are computer processing devices configured to carry out the program code by performing arithmetical, logical, and input/output operations. Once the program code is loaded into the one or more processors, the one or more processors may be programmed to perform the program code, thereby transforming the one or more processors into special purpose processor(s).

The first and second storage devices 120 and 130 may store data processed by the operation of the host 110. The first and second storage device 120 and 130 may have different structures. For example, the first storage device 120 may be a hard disk drive (HDD) and the second storage device 130 may be a solid state drive (SSD). The first storage device 120 may have higher storage capacity than the second storage device 122. The second storage device 130 may have higher operating speed (e.g., write and read speeds of data) than the first storage device 120.

In some example embodiments, the second storage device 130 may be a storage device using a flash memory. The flash memory may include a plurality of memory blocks. Each of the memory blocks may include a plurality of pages. Read and write operations of the flash memory may be performed in units of pages. An erase operation of the flash memory may be performed in units of blocks. The flash memory is configured to not perform an overwrite operation on the same physical address. Accordingly, the flash memory may manage a mapping table between a logical address and a physical address through a flash translation layer (FTL). Because the flash memory does not perform an overwrite operation on the same physical address, the flash memory may use a method such as garbage collection and/or wear-leveling through the FTL to minimize or prevent performance degradation of the flash memory high. However, frequent occurrence of the garbage collection may reduce, for example, performance and lifetime of the flash memory.

The data stored in the first and second storage devices 120 and 130 may include hot data and cold data. The hot data refers to data that is frequently written and overwritten and is expected to be overwritten in the near future. For example, log data periodically written may be hot data. The cold data refers to data that is not overwritten within a certain period of time and is not expected to be overwritten for a certain period of time in the future. For example, an image file that is not written for a certain period of time after being initially stored may be cold data.

Each memory block of the flash memory may include hot data and cold data. An execution count of the garbage collection may vary depending on a ratio between the hot data and the cold data. For example, the garbage collection may not be executed in a memory block storing only or predominantly the cold data. A memory block storing only or predominantly the hot data may include a low ratio of valid pages after the lapse of desired (or alternatively, predetermined) time. Thus, the memory block storing only or predominantly the host data may execute garbage collection while minimizing read and write operations.

The memory system 100 may read original data from, for example, the first storage device 120 during a data migration operation. The memory system 100 may identify metadata of files included in the original data through the file system 112 included in the host 110. The memory system 100 may re-arrange the files included in the original data through a migration application 111 included in the host 110 according to the metadata. That is, the memory system 100 may re-arrange the files included in the original data according to, for example, time sequence of files, or file properties of the files. The memory system 100 may store the files included in the original data in, for example, the second storage device 130 according to the re-arrangement. Thus, when the second storage device 130 uses a flash memory, the second storage device 130 may store the hot data and the cold data in different memory blocks, respectively. As a result, the second storage device 130 may minimize execution of the garbage collection operations.

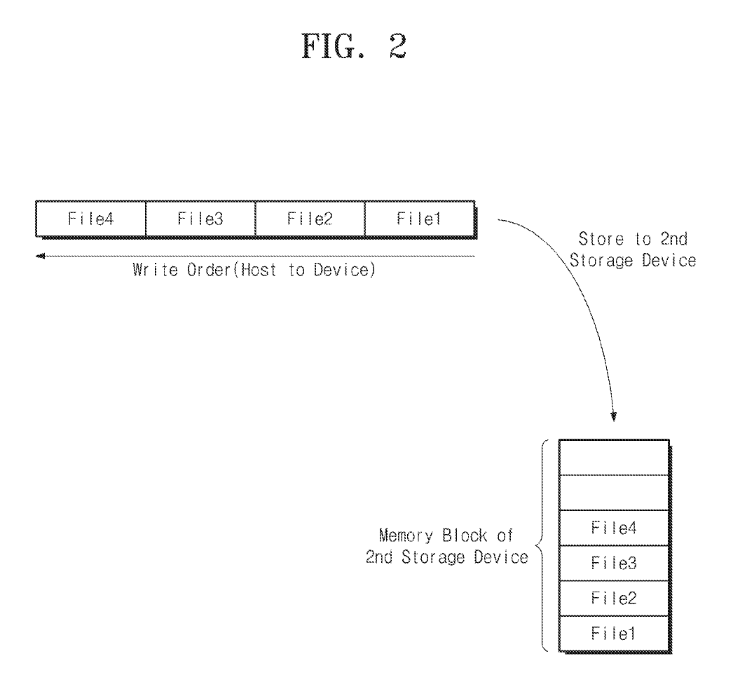

FIG. 2 illustrates a data write operation in the second storage device 130 in FIG. 1. Referring to FIGS. 1 and 2, the host 110 may transmit files to perform a write operation. For example, the host 110 may transmit four files File1 to File4. Hereinafter, an example will be described where the host 110 transmits a write command of the four files File1 to File4 to the second storage device 130. However, the host 110 may transmit a writer command of more files.

The host 110 may generate a write order sequence of the first to fourth files File1 to File4. For example, the host 110 may generate a write order sequence to sequentially store the first to fourth files File1 to File4. The second storage device 130 may sequentially store the first to fourth files File1 to File4 according to the write order sequence. For example, the second storage device 130 may store the first file File1 into a first page of a memory block according to the write order sequence. Then the second storage device 130 may sequentially store the second to fourth files File2 to File4 in corresponding pages according to the write order sequence. Thus, the second storage device 130 may sequentially store files according to the write order sequence without considering properties of the files.

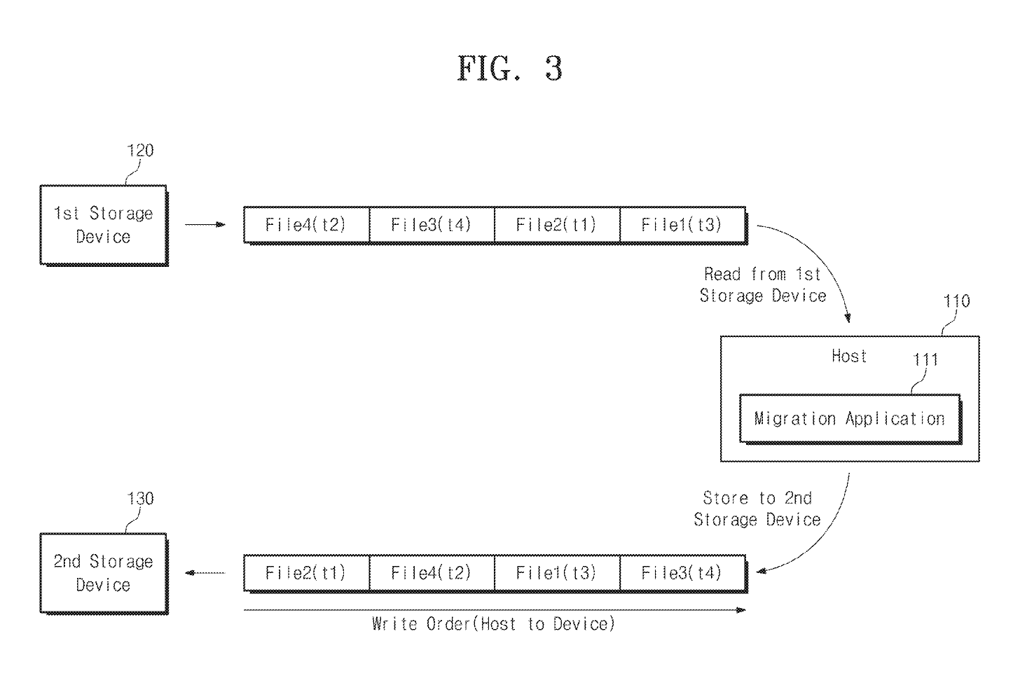

FIG. 3 illustrates a method of performing data migration based on file time information according to example embodiments of inventive concepts. Referring to FIGS. 1 and 3, the second storage device 130 may store the first to fourth files File1 to File4 based on file time information.

The host 110 may receive a data migration request for the first to fourth files File1 to File4. The host 110 may read the first to fourth files File1 to File4 corresponding to data migration from, for example, the first storage device 120 in a sequence from the first file File1 to the fourth file File4 in response to the received data migration request. The files File1 to File4 may be different in creation time or modification time. For example, the first file File1 may be created or modified at time t3. The second file File2 may be created or modified at time t1. The third file File3 may be created or modified at time t4. The fourth file File4 may be created or modified at time t2.

The migration application 111 may receive metadata of the files File1 to File4 from the file system 112. For example, the migration application 111 may receive, for example, creation time, modification time or file property information of the files File1 to File4. The migration application 111 may re-arrange the files File1 to File4 according to, for example, the creation time, modification time, or file property information of the files File1 to File4. Thus, the migration application 111 may generate a write order sequence according to the re-arrangement based on the creation time, the modification time or the file property. For example, the migration application 111 may generate the write order sequence in a sequence from the second file File2 created or modified at time t1 to the third file File3 created or modified at time t4. In some example embodiments, the migration application 111 may generate a write order sequence in a sequence from the third file File3 created or modified at the time t4 to the second file File2 created or modified at the time t1.

The host 110 may perform a write operation of the files File1 to File4 in the second storage device 130 according to the write order sequence. For example, the second storage device 130 may store the second file File2, the fourth file File4, the first file File1, and the third file File3 in this order named. In some example embodiments, the second storage device 130 may store the third file File3, the first file File1, the fourth file File4, and the second file File2 in this order named.

The memory system 100 may read original data from, for example, the first storage device 120 during a data migration operation. The memory system 100 may identify metadata of files included in the original data through the file system 112, which is included in the host 110. The memory system 100 may re-arrange the files included in the original data according to the metadata through the migration application 111, which is included in the host 110. That is, the memory system 100 may re-arrange the files included in the original data in a desired (or alternatively, predetermined) order according to, for example, time sequence of the files, or file properties of the files. The memory system 100 may store in the second storage device 130 the files included in the original data according to the re-arrangement. Thus, when the second storage device 130 uses a flash memory, the second storage device 130 may store hot data and cold data in different memory blocks, respectively. As a result, the second storage device 130 may minimize execution of the garbage collection operations.

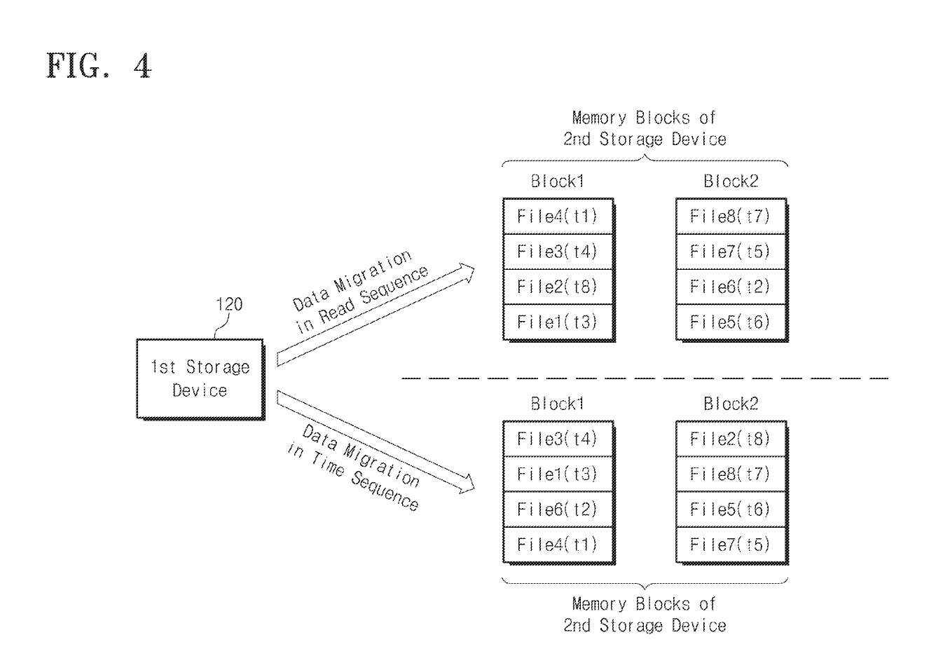

FIG. 4 is a writing method in a second storage device by data migration based on file time information. The data migration may be classified into a case where data migration is performed based on a read sequence of files included in original data and a case where data migration is performed based on time information of files included in original data.

First, the case where data migration is performed depending on a read sequence of files included in original data will now be described. Original data read from, for example, the first storage device 120 may be read in the order from a first file File1 to an eighth file File8. A write order sequence may be generated in the order from the first file File1 to the eighth file File8. Accordingly, for example, the second storage device 130 may store the original data in the order from the first file File1 to the eighth file File8. As a result, first and second blocks Block1 and Block2 of the second storage device 130 may include host data and cold data at the same ratio as or a similar ratio to the original data.

Next, the case data migration is performed depending on time information of files included in original data will now be described. Original data may be read in the order from a first file File1 to an eighth file File8. Creation times and modification times of files File1 to File8 may be different from each other. For example, times t1 to t8 represent the creation times or modification times of the files File1 to File8. The host 110 may re-arrange the files File1 to File8 in the order from the file File4, which is created or modified at the time t1, to the file File2, which is created or modified at the time t8, with reference to file time information to generate a write order sequence. The second storage device 130 may store the files File1 to File8 according to the write order sequence generated based on the file time information. Thus, the first memory block Block1 of the second storage device 130 may include only or predominantly hot data and the second block Block2 of the second storage device 130 may include only or predominantly cold data.

The memory system 100 may re-arrange original data through the migration application 111 included in the host 110 depending on file time information and store the re-arranged original data in the second storage device 130 during a data migration operation. Thus, the second storage device 130 may store hot data and cold data in different memory blocks, respectively. As a result, when the second storage device 130 uses a flash memory, the second storage device 130 may minimize execution of garbage collection.

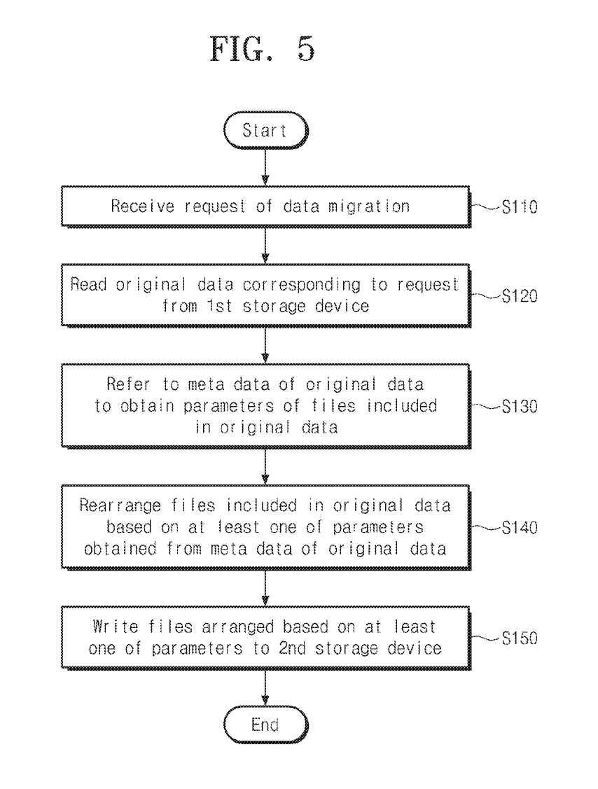

FIG. 5 is a flowchart illustrating a data migration method based on metadata of original data according to an example embodiment of inventive concepts. Referring to FIG. 5, original data read from, for example, the first storage device 120 may be stored in, for example, the second storage device 130 in an order based on the metadata.

The host 110 may receive a data migration request (S110). For example, the host 110 may receive the data migration request through a user interface.

The host 110 may read original data corresponding to the data migration request from, for example, the first storage device 120 (S120). The device driver 114 may receive a read request of the original data from the operating system 113. The device driver 114 may transmit a message corresponding to the received read request to, for example, the first storage device 120 in response to the received read request. The first storage device 120 may transmit the original data to host 110 in response to the message of the device driver 114. For example, hot data and cold data may be mixed in the original data.

The host 110 may obtain parameters of files included in the original data with reference to metadata of the original data (S130). For example, the parameters may include creation time, modification time or file properties of the files included in the original data. The file properties may include, for example, file types, file sizes, or compression statuses of the files.

The host 110 may re-arrange the files included in the original data based on at least one of the obtained parameters (S140). For example, the files may be re-arranged according to their creation order. The files may be re-arranged according to their modification order. The files may be re-arranged according to their sizes. The files may be re-arranged in the order decided based on file types. The host 110 may combine some of the parameters to determine a re-arrangement order.

The host 110 may store the files re-arranged based on at least one of the parameters in the second storage device 130 (S150). For example, the host 110 may store the files included in the original data in, for example, the second storage device 130 according to the re-arrangement decided in S140 based on, for example, the creation times, the modification times, or the file properties.

According to the above-described method, the memory system 100 may re-arrange files included in original data according to metadata and store the re-arranged files in the second storage device 130 during a data migration operation. Thus, when the second store device 130 uses a flash memory, the second storage device 130 may store hot data and cold data in different memory blocks, respectively. As a result, the second storage device 130 may minimize execution of garbage collection.

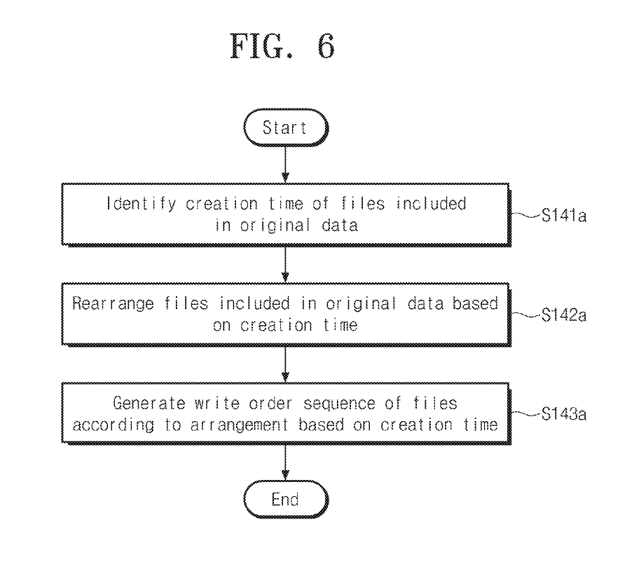

FIG. 6 is a flowchart illustrating a method of arranging files included in original data based on a parameter obtained from the metadata in FIG. 5. Referring to FIG. 6, the memory system 100 may re-arrange files of original data according to creation time to generate a write order sequence.

The migration application 111 may identify creation time of the files included in the original data from the first storage device 120 (S141a). For example, the migration application 111 may receive from the file system 112 the creation time of the files included in the original data.

The migration application 111 may re-arrange the files included in the original data based on the creation time (S142a). For example, the migration application 111 may re-arrange the original data in the order from the first generated file to the last generated file. In some example embodiments, the migration application 111 may re-arrange the original data in the order from the last generated file to the first generated file.

The migration application 111 may generate a write order sequence of the files included in the original data re-arranged based on the creation time (S143a). For example, the migration application 111 may generate the write order sequence in the order from the first generated file to the last generated file. In some example embodiments, the migration application 111 may generate the write order sequence in the order from the last generated file to the first generated file. The original data may be transmitted to the second storage device 130 through the device driver 114 according to the write order sequence.

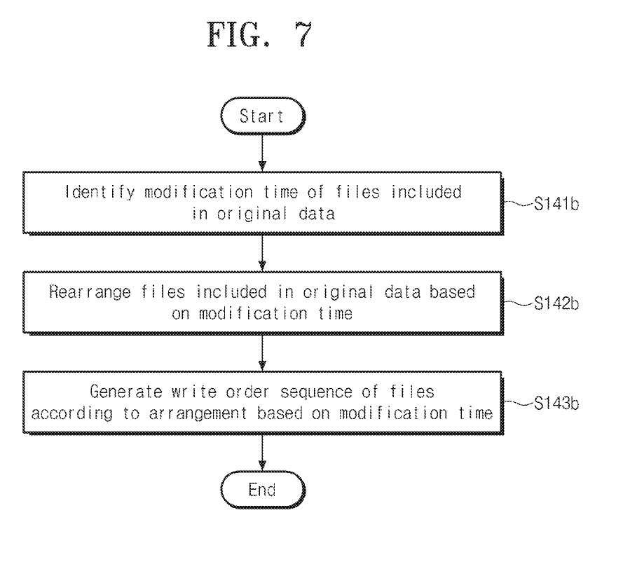

FIG. 7 is a flowchart illustrating another method of arranging files included in original data based on a parameter obtained from the metadata in FIG. 5. Referring to FIG. 7, the memory system 100 may re-arrange files of original data according to modification time and generate a write order sequence based on the re-arrangement.

The migration application 111 may identify modification time of the files included in the original data read from the first storage device 120 (S141b). For example, the migration application 111 may receive from the file system 112 modification time information of the files included in the original data.

The migration application 111 may re-arrange the files included in the original data based on the modification time (S142b). For example, the migration application 111 may re-arrange the original data in the order from the first modified file to the last modified file. In some example embodiments, the migration application 111 may re-arrange the original data in the order from the last modified file to the first modified file.

The migration application 111 may generate a write order sequence of the files included in the original data re-arranged based on the modification time (S143b). For example, the migration application 111 may generate the write order sequence in the order from the first modified file to the last modified file. In some example embodiments, the migration application 111 may generate the write order sequence in the order from the last modified file to the first modified file. The original data may be transmitted to the second storage device 130 through the device driver 114 according to the write order sequence.

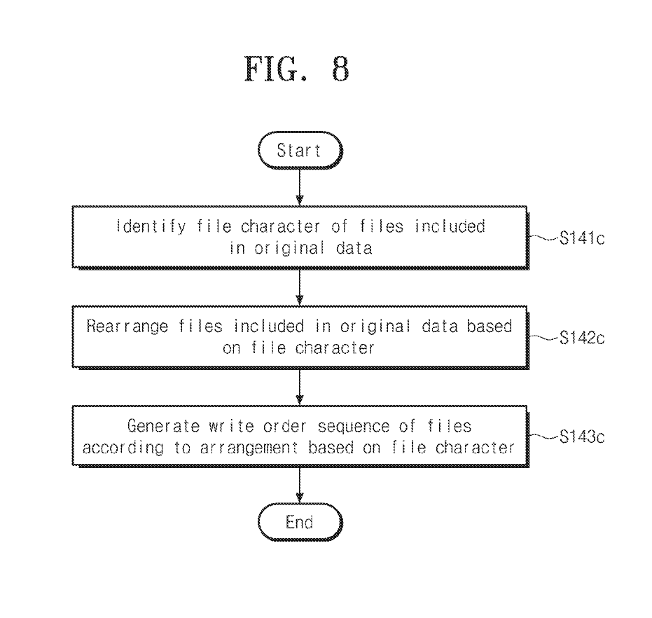

FIG. 8 is a flowchart illustrating still another method of arranging files included in original data based on a parameter obtained from the metadata in FIG. 5. Referring to FIG. 8, the memory system 100 may re-arrange files of original data according to file properties and generate a write order sequence based on the re-arrangement.

The migration application 111 may identify file properties of the files included in the original data read from the first storage device 120 (S141c). For example, the migration application 111 may receive from the file system 112 the file properties of the files included in the original data. The file properties may include, for example, file types, file sizes, or compression statuses of the files.

The migration application 111 may re-arrange the files included in the original data based on the file properties (S142c). For example, the files may be re-arranged according to their sizes. The files may be re-arranged according to file types. For example, the migration application 111 may combine at least some of the parameters to determine a re-arrangement order. However, the file properties are not limited thereto. For example, the migration application 111 may re-arrange the original data in the order from a frequently modified file to a infrequently modified file.

The migration application 111 may generate a write order sequence of the files included in the original data re-arranged based on the file properties (S143c). For example, the migration application 111 may generate the write order sequence according to their sizes. The migration application 111 may generate the write order based on file types. The migration application 111 may generate the write order sequence in the order decided by combining a plurality of parameters. The original data may be transmitted to, for example, the second storage device 130 through the device driver 114 according to the write order sequence.

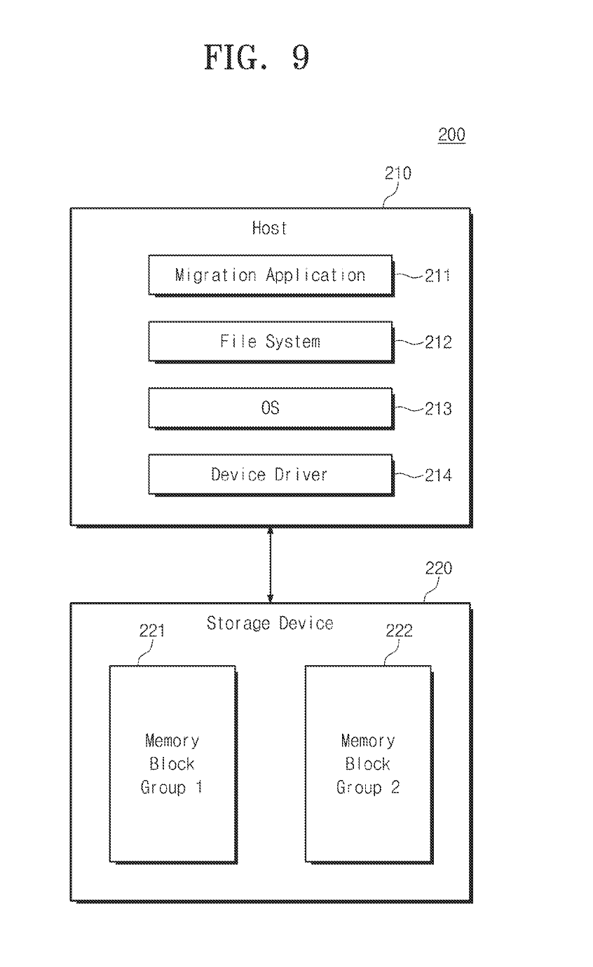

FIG. 9 is a block diagram of a memory system 200 according to an example embodiment of inventive concepts. As illustrated, the memory system 200 may include a host 210 and a storage device 220. The storage device 220 may include a plurality of memory block groups. For example, the storage device 220 may include first and second memory block groups 221 and 222. Each of the memory block groups may include a plurality of memory sub-blocks.

For example, data migration may be performed between the first and second memory block groups 221 and 222. The host 210 may receive a data migration request for, for example, the first memory block group 221. The host 210 may read files included in the first memory block group 221 in response to the data migration request. A migration application 211 may obtain from a file system 212, for example, creation times, modification times, or file properties of the read files included in the first memory block group 221. The migration application 211 may re-arrange the read files included in the first memory block group 221 according to information on, for example, the creation times, the modification times, or the file properties. For example, the migration application 211 may generate a write order sequence in the order of the creation times. The migration application 211 may generate a write order sequence in the order of the modification times. The migration application 211 may generate a write order sequence in the order determined based on file properties.

The host 210 may transmit classified files to the storage device 220 according to the write order sequence. The storage device 220 may store the transmitted files in the second memory block group 222 according to the write order sequence. Thus, the files read from the first memory block group 221 after being divided into host data and cold data may be stored in different memory blocks of the second memory block group 222.

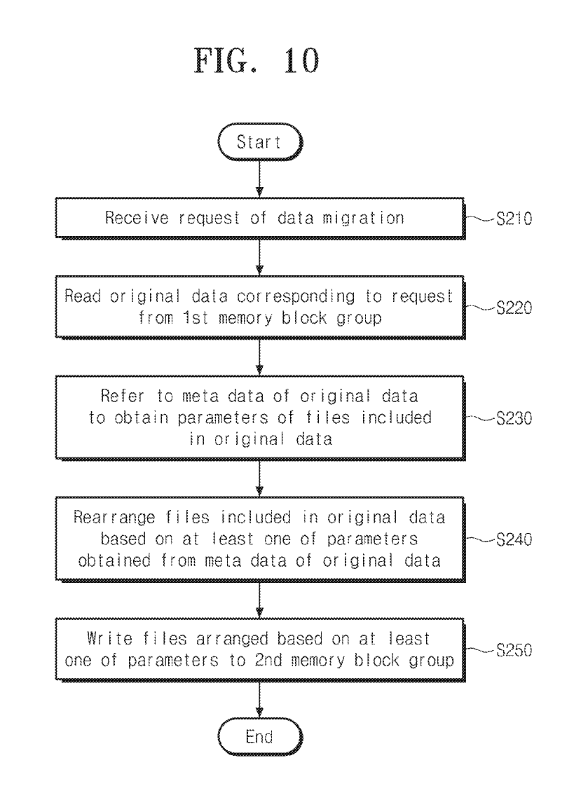

FIG. 10 is a flowchart illustrating another data migration method based on metadata of original data according to an example embodiment of inventive concepts. Referring to FIGS. 9 and 10, original data read from the first memory block group 221 may be stored in the second memory block group 222 in the order based on metadata.

The host 210 may receive a data migration request (S210). For example, the host 210 may receive the data migration request through a user interface.

The host 210 may read original data corresponding to the data migration request from, for example, the first memory block group 221 (S220). The device driver 214 may receive a read request of the original data from an operating system 213. The device driver 214 may transmit a message corresponding to the received read request to the first memory block group 221 in response to the received read request. The first memory block group 221 may transmit the original data to the host 210 in response to the message of the device driver 214.

The host 210 may obtain parameters of files included in the original data with reference to metadata of the original data (S230). For example, the parameters may include creation time, modification time, file properties of the files include in the original data. The file properties may include file types, file sizes or compression statuses of the files.

The host 210 may re-arrange the files included in the original data based on at least one of the obtained parameters (S240). For example, the files may be re-arranged in the order of the creation time. The files may be re-arranged in the order of the modification time. The files may be re-arranged according to the file size. The files may be re-arranged in the order decided depending on the same type according to the file type. The host 210 may combine a plurality of parameters to decide an order.

The host 210 may store the files re-arranged based on at least one of the parameters in the second memory block group 222 (S250). For example, the host 110 may store the files included in the original data in the second memory block group 222 according to the re-arranged decided in S140 based on the creation times, the modification times or the file properties.

The flowcharts illustrated in FIGS. 6-8, which show methods of arranging files included in original data based on various parameters (e.g., creation time, modification time, file character, etc.) obtained from the metadata of the original data, may be regarded as specific implementation examples of FIG. 10 when the first and second storage devices are replaced with the first and second memory block groups, respectively.

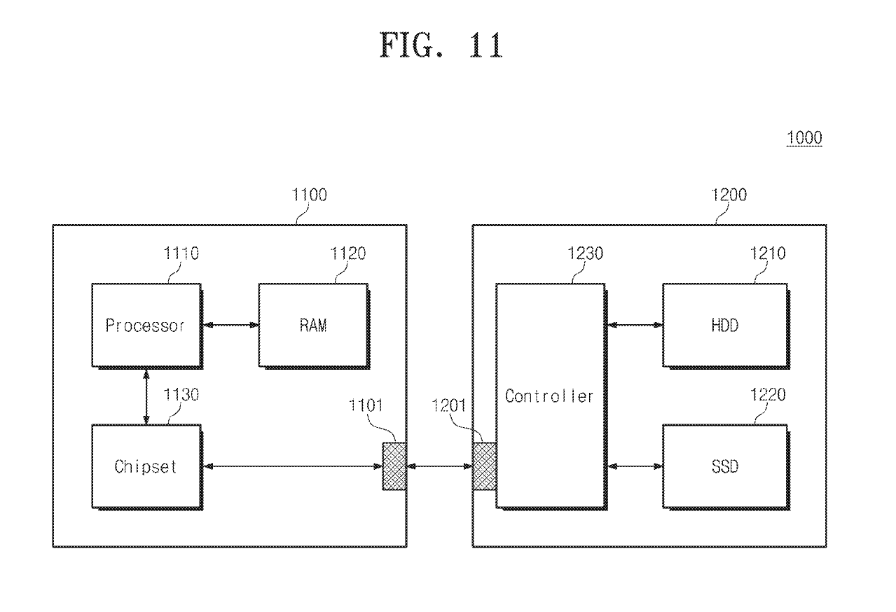

FIG. 11 is a block diagram of a user system 1000 according to an example embodiment of inventive concepts. As illustrated, the user system 1000 includes a host 1100 and a memory system 1200. The host 1100 may include a processor 1110, a random access memory (RAM) 1120, and a chipset 1130.

The processor 1110 may control the overall operation of the user system 1000. For example, the processor 1110 may control devices included in the user system 1000 and perform an operation to interpret a program command. In some example embodiments, the data migration described with reference to FIGS. 1 to 10 may be performed through the processor 1110. That is, when data migrates from an HDD 1210 to an SSD 1220, the processor 1110 may allow original data to migrate through the methods described with reference to FIGS. 1 to 10.

The RAM 1120 may serve as a main memory device of the host 1100. The RAM 1120 may function as a buffer between the processor 1110 and the memory system 1200. In example embodiments, the RAM 1120 may be provided as one of random access memories such as dynamic random access memory (DRAM), synchronous DRAM (SDRAM), static RAM (SRAM), double date rate SDRAM (DDR SDRAM), DDR2 SDRAM, DDR3 SDRAM, phase-change RAM (PRAM), magnetic RAM (MRAM), and resistive RAM (RRAM).

The chipset 1130 is a device to control hardware of the user system 1000 according to the control of the processor 1110. For example, the chipset 1130 may control a control signal of the memory system 1200 according to the control of the processor 1110.

The memory system 1200 may store data generated by the operation of the host 1100 or data received from an external device. The memory system 1200 may include the HDD 1210, the SSD 1220, and a controller 1230. The HDD 1210 and the SSD 1220 may store data generated by the operation of the host 1100 or data received from an external device. The HDD 1210 may operate based on a magnetic disk. The SSD 1220 may operate based on a semiconductor memory device. The memory controller 1230 may control the operation of the HDD 1210 or the SSD 1220. In some example embodiments, the memory system 1200 may be provided as a module including the HDD 1210, the SSD 1220, and the controller 1230. The host 1100 and the memory system 1200 may be connected based on sockets 1101 and 1201 to exchange a signal with each other. In some example embodiments, the host 1100 and the memory system 1200 of the user system 1000 may operate based on the method described with reference to FIGS. 1 to 10.

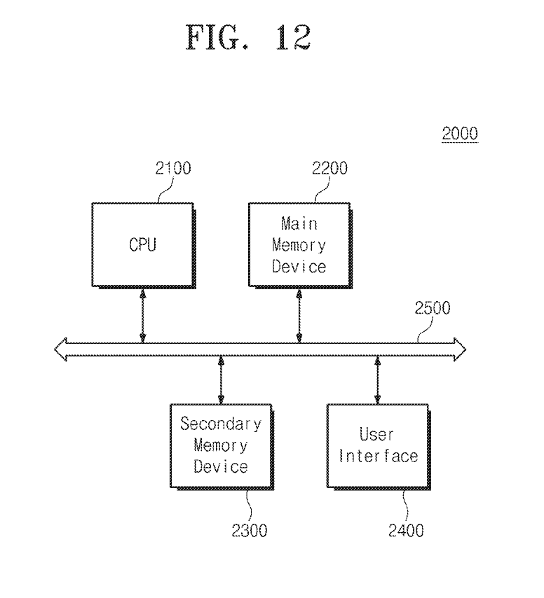

FIG. 12 is a block diagram of a user system 2000 according to an example embodiment of inventive concepts. As illustrated, the user system 2000 includes a central processing unit (CPU) 2100, a main memory device 2200, a secondary memory device 2300, a user interface 2400, and a system bus 2500.

The CPU 2100 may control operations of devices included in the user system 2000 and interprets or executes a program name. In some example embodiments, the data migration described with reference to FIGS. 1 to 11 may be performed by the CPU 2100.

The main memory device 2200 may temporarily store data or a program to be executed by the CPU 2100 to buffer operating speed between the CPU 2100 and the secondary memory device 2300. In some example embodiments, the main memory device 2200 may be provided as one of random access memories such as dynamic random access memory (DRAM), synchronous DRAM (SDRAM), static RAM (SRAM), double date rate SDRAM (DDR SDRAM), DDR2 SDRAM, DDR3 SDRAM, phase-change RAM (PRAM), magnetic RAM (MRAM), and resistive RAM (RRAM). In some example embodiments, the main memory device 2200 may function as a buffer between the CPU 2100 and the secondary memory device 2300.

The secondary memory device 2300 may store a program or data. In some example embodiments, the secondary memory device 2300 may include a plurality of storage devices. For example, the secondary memory device 2300 may be a hybrid memory system or a heterogeneous memory system in which an HDD and an SSD are combined. In some example embodiments, the secondary memory device 2300 may be driven based on the operating method of a memory system described with reference to FIGS. 1 to 10.

The user interface 2400 may provide input/output operations to allow a user to control the user interface 200.

The system bus 2500 may provide a channel that is connected to the CPU 2100, the main memory device 2200, the secondary memory device 2300, and the user interface 2400 to transmit data.

As described above, files included in original data are arranged in a desired (or alternatively, predetermined) order depending on at least one parameter with reference to metadata corresponding to the files during data migration. The files are stored in a target storage device in the desired (or alternatively, predetermined) order to prevent reduction in performance and lifetime of a storage device.

The above-disclosed subject matter is to be considered illustrative, and not restrictive, and the appended claims are intended to cover all such modifications, enhancements, and other features, which fall within the true spirit and scope of inventive concepts. Thus, to the maximum extent allowed by law, the scope of inventive concepts is to be determined by the broadest permissible interpretation of the following claims and their equivalents, and shall not be restricted or limited by the foregoing detailed description. While some example embodiments have been particularly shown and described, it will be understood by one of ordinary skill in the art that variations in form and detail may be made therein without departing from the spirit and scope of the claims.

What is claimed is:

1. A data migration method of a memory system including first and second storage devices, the data migration method comprising:
performing a read operation of original data stored in the first storage device in response to a data migration request;
obtaining parameters of files included in the original data with reference to metadata of the original data;
re-arranging the files based on at least one of the parameters; and
storing the files included in the original data in the second storage device according to the re-arrangement.

2. The data migration method as set forth in claim 1, wherein
the second storage device includes a plurality of memory blocks.

3. The data migration method as set forth in claim 2, wherein
the data migration request is received with respect to data having at least one of the memory blocks or with respect to an entire data of the first storage device.

4. The data migration method as set forth in claim 2, wherein
the re-arranging includes,
identifying, from a file system, creation time information of the files included in the original data,
re-arranging the files included in the original data according to the creation time information in a set order, and
generating a write order sequence of the files included in the original data according to the re-arrangement.

5. The data migration method as set forth in claim 4, wherein
the storing includes storing the files included in the original data in the second storage device according to the creation time information in an order from the first created file to the last created file.

6. The data migration method as set forth in claim 4, wherein
the storing includes storing the files included in the original data in the second storage device according to the creation time information in an the order from the last created file to the first created file.

7. The data migration method as set forth in claim 1, wherein
the re-arranging includes,
identifying, from a file system, modification time information of the files included in the original data;
re-arranging the files included in the original data according to the modification time information in a set order; and
generating a write order sequence of the files included in the original data according to the re-arrangement.

8. The data migration method as set forth in claim 7, wherein
the storing includes storing the files included in the original data in the second storage device according to the modification time information in the order from the first modified file to the last modified file.

9. The data migration method as set forth in claim 7, wherein
the storing includes storing the files included in the original data in the second storage device according to the modification time information in the order from the last modified file to the first modified file.

10. The data migration method as set forth in claim 1, wherein
the re-arranging includes,
identifying, from a file system, file property information of the files included in the original data;
re-arranging the files included in the original data according to the file property information in a set order; and
generating a write order sequence of the files included in the original data according to the re-arrangement.

11. The data migration method as set forth in claim 10, wherein
the storing includes storing the files included in the original data in the second storage device in an order based on the file property information.

12. A data migration method of a memory system including first memory blocks and second memory blocks, the data migration method comprising:
performing a read operation of original data stored in the first memory blocks in response to a data migration request;
obtaining parameters of files included in the original data with reference to metadata of the original data;
re-arranging the files based on at least one of the parameters; and
storing the files included in the original data in the second memory blocks according to the re-arrangement.

13. The data migration method as set forth in claim 12, wherein
the re-arranging includes,
identifying, from a file system, creation time information of the files included in the original data,
re-arranging the files included in the original data according to the creation time information in a set order, and
generating a write order sequence of the files included in the original data according to the re-arrangement.

14. The data migration method as set forth in claim 12, wherein
the re-arranging includes,
identifying, from a file system, modification time information of the files included in the original data,
re-arranging the files included in the original data according to the modification time information in a set order, and
generating a write order sequence of the files included in the original data according to the re-arrangement.

15. The data migration method as set forth in claim 12, wherein
the re-arranging includes,
identifying, from a file system, file property information of the files included in the original data,
re-arranging the files included in the original data according to the file property information in a set order, and
generating a write order sequence of the files included in the original data according to the re-arrangement.

16. A data migration method of a memory system including first and second storage devices, the data migration method comprising:
reading original data stored in the first storage device in response to a data migration request;
obtaining parameters of files with reference to metadata of the original data;
re-arranging the files included in the original data based on at least one of the parameters;
generating a write order sequence for the re-arranged files based on set criteria; and
writing the files in the second storage device according to the write order sequence.

17. The data migration method as set forth in claim 16, wherein the second storage device includes a flash memory based memory device.

18. The data migration method as set forth in claim 16, wherein the parameters include at least one of creation time information, modification time information, file size information, file type information, and file compression information.

19. The data migration method as set forth in claim 16, wherein the re-arranging includes classifying the files into hot data and cold data based on at least one of a frequency of overwrites and a prediction of future overwrites.

20. The data migration method as set forth in claim 19, wherein the writing includes storing the hot data and the cold data in a first memory block and a second memory block of the second storage device, respectively.
